(19) United States
(12) Patent Application Publication
(10) Pub. No.: US 2021/0051039 A1
(43) Pub. Date: Feb. 18, 2021

(54) DATA SYNCHRONIZATION METHOD AND ELECTRICAL APPLIANCE CONTROL SYSTEM

(71) Applicant: Nanjing Silergy Micro Technology Co., Ltd., Nanjing (CN)

(72) Inventor: Junjie Qiao, Nanjing (CN)

(21) Appl. No.: 16/983,144

(22) Filed: Aug. 3, 2020

(30) Foreign Application Priority Data
Aug. 14, 2019 (CN) 201910750298.0

(51) Int. Cl. H04L 12/28; H04W 4/80; H04W 76/10; H04W 56/00; H04W 4/06; G08C 17/02

(52) U.S. Cl. CPC H04L 12/2807; H04W 4/80; H04W 76/10; H04W 84/18; H04W 4/06; G08C 17/02; H04L 12/282; H04W 56/001

(57) ABSTRACT

A data synchronization method for synchronizing data between first and second devices can include: establishing, by the second device, a communication connection with the first device, in accordance with a connectable broadcast sent by the first device; obtaining, by the second device, configuration data and status data of the electrical appliances stored in the first device; merging, by the second device, the obtained configuration data and status data of the electrical appliances with local configuration data and status data of the electrical appliances; sending, by the second device, the merged configuration data and status data of the electrical appliances to the first device, in order to realize synchronization; and where the first device is one of a smart terminal and a remote controller, and the second device is the other one of the smart terminal and the remote controller.

### RELATED APPLICATIONS

This application claims the benefit of Chinese Patent Application No. 201910750298.0, filed on Aug. 14, 2019, which is incorporated herein by reference in its entirety.

### FIELD OF THE INVENTION

The present invention generally relates to the field of smart control, and more particularly to data synchronization methods and electrical appliance control systems.

### BACKGROUND

Increasingly, smart devices that are closely related to daily necessities are greatly facilitating people's lives. Most smart devices are equipped with remote controllers and smart terminals to control the smart devices. However, the smart terminal and the remote controller typically only separately control the smart device. In addition, due to design limitations of the remote controller, the remote controller may only realize relatively simple operation control, and not operation commands with higher requirements. Also, both the smart terminal and the remote controller may only control a certain kind of smart device at a given time, and simple and effective control of a situation where multiple smart devices are found may not be supported.

### BRIEF DESCRIPTION OF THE DRAWINGS

FIG. 1 is a schematic block diagram of an example electrical appliance control system, in accordance with embodiments of the present invention.

FIG. 2 is a schematic block diagram of an example electrical appliance control system, in accordance with embodiments of the present invention.

FIG. 3 is a flow diagram of an example process for data synchronization, in accordance with embodiments of the present invention.

FIG. 4 is a flow diagram of an example process for obtaining the status data of the smart light in the remote controller by the smart terminal, in accordance with embodiments of the present invention.

FIG. 5 is a flow diagram of an example process for obtaining the data request of the remote controller by the smart terminal, in accordance with embodiments of the present invention.

FIG. 6 is a flow diagram of an example process for configuring the status data of the smart lights in the remote controller by the smart terminal, in accordance with embodiments of the present invention.

FIG. 7 is a flow diagram of an example process for configuring the data of the remote controller by the smart terminal, in accordance with embodiments of the present invention.

FIG. 8 is a diagram of an example operation state transition, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

In one embodiment, a data synchronization method for synchronizing data between a first device and a second device, wherein the first and second devices are configured to send configuration instructions to control electrical appliances to join a mesh network and send control instructions to the electrical appliances that join the mesh network, can include: (i) establishing, by the second device, a communication connection with the first device, in accordance with a connectable broadcast sent by the first device; (ii) obtaining, by the second device, configuration data and status data of the electrical appliances stored in the first device; (iii) merging, by the second device, the obtained configuration data and status data of the electrical appliances with local configuration data and status data of the electrical appliances; (iv) sending, by the second device, the merged configuration data and status data of the electrical appliances to the first device, in order to realize synchronization; and (v) where the first device is one of a smart terminal and a remote controller, and the second device is the other one of the smart terminal and the remote controller.

In one embodiment, an electrical appliance control system can include: (i) a plurality of electrical appliance control units configured to receive configuration instructions to join a mesh network, and to control corresponding electrical appliances according to control instructions received from the mesh network; and (ii) a smart terminal and a remote controller configured to send the configuration instruction and the control instruction to the electrical appliance control units, and to synchronize configuration data and appliance state data through a communication connection.

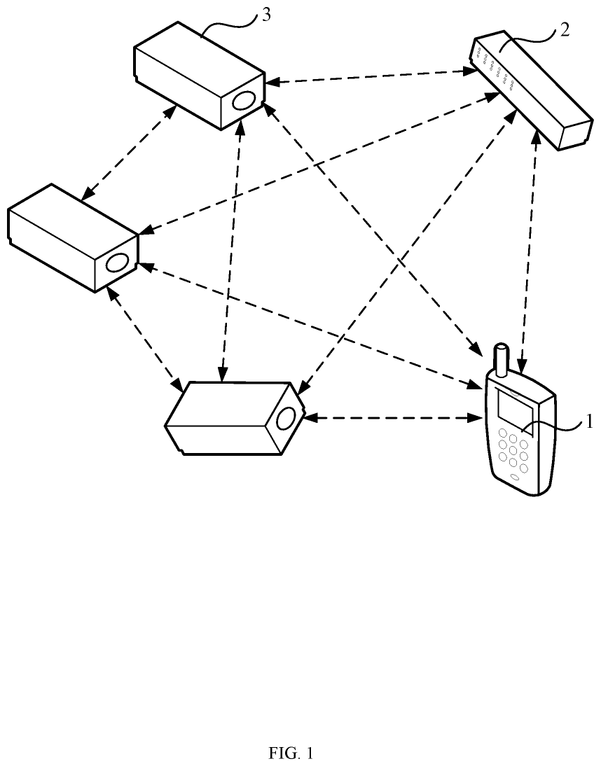

Referring now to FIG. 1, shown is a schematic block diagram of an example electrical appliance control system, in accordance with embodiments of the present invention. The electrical appliance control system includes smart terminal 1, remote controller 2, and electrical appliance control units 3. Here, smart terminal 1 and remote controller 2 can send configuration instructions and control instructions to electrical appliance control unit 3 through the wireless network respectively. Electrical appliance control unit 3 may perform corresponding grouping and mesh networking according to the received configuration instructions. After the configuration is completed, the state of the electrical appliance corresponding to electrical appliance unit 3 can be controlled according to the received control instructions. Also, smart terminal 1 and remote controller 2 can also synchronize the configuration data and the status data of the electrical appliances through a communication connection, such that smart terminal 1 and remote control 2 can perform the same control on electrical appliance control unit 3 in the same group. In addition, the functions of the buttons on remote controller 2 can be customized through smart terminal 1, such that remote controller 2 can realize the combination of complex functions, thereby realizing the effective control of the electrical appliances.

In particular embodiments, electrical appliance control units 3 can receive configuration instructions to join the mesh network, and may control the corresponding electrical appliances according to the control instructions received from the mesh network. Smart terminal 1 and remote controller 2 can send the configuration instructions and the control instructions to electrical appliance control units 3. Here, smart terminal 1 and remote controller 2 can also synchronize the configuration data and the status data of the electrical appliances through the communication connection.

In particular embodiments, the electrical appliances in the electrical appliance control system may be one or more of smart appliances (e.g., smart lights, air conditioners, refrigerators, televisions, etc.). Each electric appliance control unit 3 can be installed in each smart appliance to receive the configuration instructions sent by smart terminal 1 and remote controller 2 through the wireless network, join the mesh network according to the configuration instructions, and control the corresponding electric appliances according to the control instructions received from the mesh network.

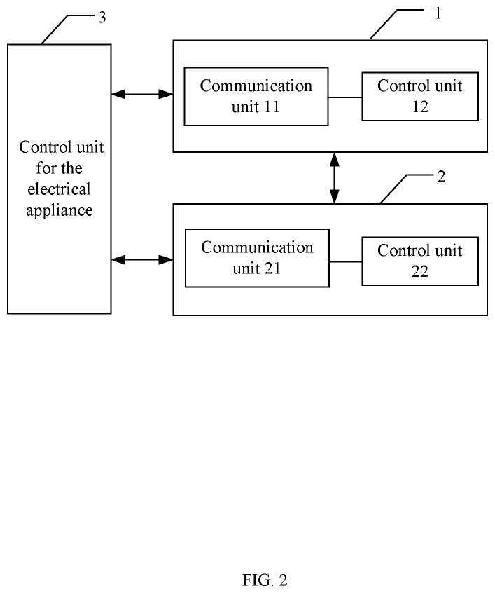

Referring now to FIG. 2, shown is a schematic block diagram of an example electrical appliance control system, in accordance with embodiments of the present invention. In this particular example, the electrical appliance control system can include smart terminal 1, remote controller 2, and electrical appliance control unit 3. Here, smart terminal 1 and remote controller 2 can send configuration instructions and control instructions to electrical appliance control unit 3. Also, electrical appliance control unit 3 can join the mesh network according to the received configuration instructions, and may control the corresponding electrical appliances according to the control instructions received from the mesh network. Here, smart terminal 1 and remote controller 2 may also synchronize configuration data and status data of the electrical appliances through the communication connection, where remote controller 2 can perform custom settings according to the configuration data.

For example, the communication connection can be a Bluetooth Low Energy (BLE) communication connection, which is realized based on BLE technology, which is a robustness wireless technology with low cost, short distance and interoperability. BLE technology adopts a variable connection time interval, which is set according to the specific application. In addition, because BLE technology applies a very fast connection method, it can usually be in a “non-connected” state (saving energy). At this time, both ends of the link may only know each other, and the link can only be opened when necessary and then closed during the shortest possible time, which can minimize power consumption. The communication among smart terminal 1, remote controller 2, and electrical appliance control unit 3 can all utilize a broadcast channel or a data channel. In the communication network, the broadcast channel (BCH) can include broadcast control channel (BCCH), frequency correction channel (FCCH), and synchronization channel (SCH). These are all unidirectional downlink channels; that is, from BTS to a mobile phone. BCCH can mainly be used to send system messages, FCCH can mainly be used to correct the frequency, SCH can be the synchronization channel, and they transmit the information in point-to-multipoint manner. The data channel supports transparent and non-transparent data services up to 9.6 kbit/s through different rate adaptation, channel coding and interleaving on full-rate or half-rate channels. When the transmitted information is simple, such as only switching commands, the broadcast channel can be used, while when the information is complex, the data channel can be used.

In this example, smart terminal 1 can include communication unit 11 and control unit 12. For example, communication unit 11 is a BLE communication unit. Control unit 12 can control communication unit 11 to send the configuration instruction and the control instruction to electrical appliance control unit 3 through the BLE broadcast channel. The configuration instruction can configure electrical appliance control unit 3 to join the mesh network, and the control instruction can control the electrical appliance corresponding to electrical appliance control unit 3. In a smart light example, when smart terminal 1 is turned on, smart terminal 1 can scan within a certain range for a predetermined time. If there is one smart light near smart terminal 1, the logo of the smart light will be displayed on smart terminal 1. Through selection, smart terminal 1 can sequentially add the scanned smart lights to the mesh network. In addition, control unit 12 of smart terminal 1 sends the control instruction to the smart light through communication unit 11 to adjust the switching, brightness, color, temperature, etc., of the smart light, and/or control multiple smart lights to be grouped, and then control the multiple smart lights in the corresponding group to simultaneously adjust the switch, brightness, color temperature, etc.

The mesh network in this example is based on the BLE protocol, and can include routers and clients. The router may form a backbone network and can be connected to the wired Internet, and may be responsible for providing multi-hop wireless Internet connection for the client. The wireless mesh network can be based on the mutual cooperation and coordination among many wireless access points distributed in mesh. This has the advantages of high-speed broadband and high spectrum efficiency. Also, this can be characterized by dynamic self-organization, self-configuration, and self-maintenance. The configuration instruction of smart terminal 1 can also include that control unit 12 communicates with remote controller 2 through the BLE data channel to synchronize the configuration data and the status data of the electrical appliances.

The configuration data can include grouping data for electrical appliance control unit 3, networking data for the mesh network, and custom data for the functions of remote controller 2. Control unit 12 can control communication unit 11 to establish the communication connection according to the connectable broadcast sent by remote controller 2, and may obtain the status data of each electrical appliance and the configuration data of each function code from remote controller 2 one by one through the communication connection. Then, control unit 12 can merge the obtained configuration data for each function code and the status data of each electrical appliance with the configuration data of each function code in smart terminal 1 and the status data of each electrical appliance in smart terminal 1, and then may send the merged configuration data and status data to remote controller 2 one by one through communication unit 11, in order to achieve synchronization.

Remote controller 2 can include communication unit 21 and control unit 22. Here for example, communication unit 21 is a BLE communication unit, and control unit 22 can control the BLE communication unit to send the configuration instruction and the control instruction to electrical appliance control unit 3 through the BLE broadcast channel. The configuration instruction can configure electrical appliance control unit 3 to join the mesh network, and the control instruction is used to control the appliance corresponding to electrical appliance control unit 3. This particular example utilizes a smart light. Remote controller 2 can network and control the smart light through the BLE broadcast channel. The panel of remote controller 2 in this example may be provided with four grouping buttons, one turn-on button, one turn-off button, two brightness adjustment buttons, and one dip switch. Each function of remote controller 2 can be realized by buttons and a combination of buttons and time.

In this example, when the dip switch is dialed to the top, remote controller 2 approaches to the smart lights that need to be networked and grouped, and then one of the grouping buttons is pressed for three seconds, if remote controller 2 receives the network access request of the smart light at this time, a networking instruction can be initiated to assign information such as address, grouping, and network key to the smart light. After the smart light is successfully networked, the smart light can flash three times to indicate successful networking. After the network is successfully connected, the dip switch can be dialed to the bottom. By selecting one of the group buttons, the smart lights in the selected group can be subsequently controlled. For example, the smart lights in the selected group can be switched and controlled by the turn-on/off button and the brightness adjustment buttons.

In addition, remote controller 2 can also establish a data connection with smart terminal 1 through a BLE data channel to perform data synchronization. Control unit 22 of remote controller 2 can synchronize configuration data and state data for the electrical appliance with smart terminal 1 through communication unit 21. The configuration data can include grouping data for electrical appliance control unit 3, networking data for the mesh network, and custom data for the functions of remote controller 2. The customized data for the functions of remote control 2 may be the configuration data for the control function of the corresponding button of remote control 2. During the data synchronization between smart terminal 1 and remote controller 2, smart terminal 1 sends the configuration data to remote controller 2, and remote control 2 can realize the corresponding control function through the configuration data.

Electrical appliance control unit 3 may refer to the control unit in the electrical appliance, and can receive the configuration instruction to control the corresponding electrical appliance to join the mesh network, and controlling the corresponding electrical appliance to realize functional operation according to the control instruction received from the mesh network. Also, electrical appliance control unit 3 can play a relay role in the wireless network connection, and can realize signal relay and amplification, thereby extending the coverage area of the wireless network. In this particular example, the electrical appliance corresponding to the electrical appliance control unit 3 is a smart light. The smart light is a light-emitting diode (LED) dimming light embedded with a BLE module, which can receive the connectable broadcast of smart terminal 1 or remote controller 2 through the BLE data channel and/or broadcast channel, and establish a data connection with smart terminal 1 or remote controller 2 for networking or control operation.

In particular embodiments, both the smart terminal and the remote controller can include the communication unit and the control unit. The control unit can control the communication unit to send the configuration instruction and the control instruction, in order to configure the electrical appliance control unit to join the mesh network, control the electrical appliance corresponding to the electrical appliance control unit, and may synchronize the configuration data and the status data of the electrical appliance between the smart terminal and the remote controller. Therefore, data synchronization between the smart terminal and the remote controller can be realized, and then the custom setting of the remote controller can be realized. At the same time, the grouping control of multiple electrical appliances can be realized.

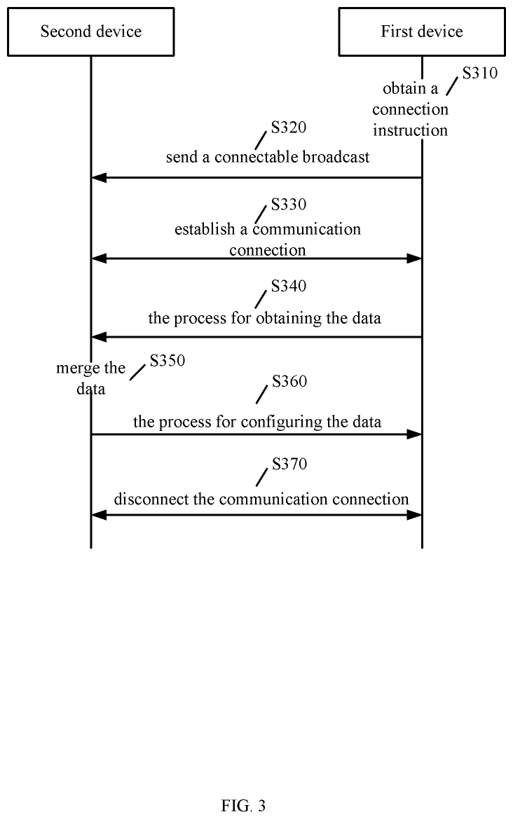

Referring now to FIG. 3, shown is a flow diagram of an example process for data synchronization in accordance with embodiments of the present invention. In this particular example, the first device is one of the smart terminal and the remote controller, and the second device is the other of the smart terminal and the remote controller. That is, the first device is the smart terminal and the second device is the remote controller; or, the first device is the remote controller and the second device is the smart terminal. An example process of data synchronization between the first device and the second device can include the following steps.

At S310, the first device can obtain a connection instruction. In this example, the first device may receive the connection instruction and triggers the data synchronization process. At S320, the first device can send a connectable broadcast in response to the connection instruction. At S330, after receiving the connectable broadcast, the second device may establish a communication connection with the first device. At S340, the first device can send the status data of each electrical appliance and the configuration data of each function code to the second device one by one through communication connection, which is the process for obtaining data. At S350, the second device can merge the obtained configuration data and status data with local configuration data and status data, which is the process for configuring data. At S360, the second device can send the merged configuration data and status data of the electrical appliances to the first device to realize synchronization. At S370, after the synchronization is completed, the communication connection between the first device and the second device may be disconnected. In this example, the first and second devices can be connected through BLE communication, and the mesh network may be based on the BLE protocol. Further, the first and second devices can communicate through a BLE broadcast channel and/or a BLE data channel.

In particular embodiments, the first device can send the connectable broadcast and the second device may establish the communication connection with the first device according to the connectable broadcast. Then, the second device can obtain the configuration data and the status data of the electrical appliances stored by the first device through the communication connection, merge them with local configuration data and status data of the electrical appliances, and send the merged configuration data and status data of the electrical appliances to the first device. The first device can be one of the smart terminal and the remote controller, and the second device is the other of the smart terminal and the remote controller. Therefore, the data synchronization between the smart terminal and the remote controller can be realized to achieve the same control.

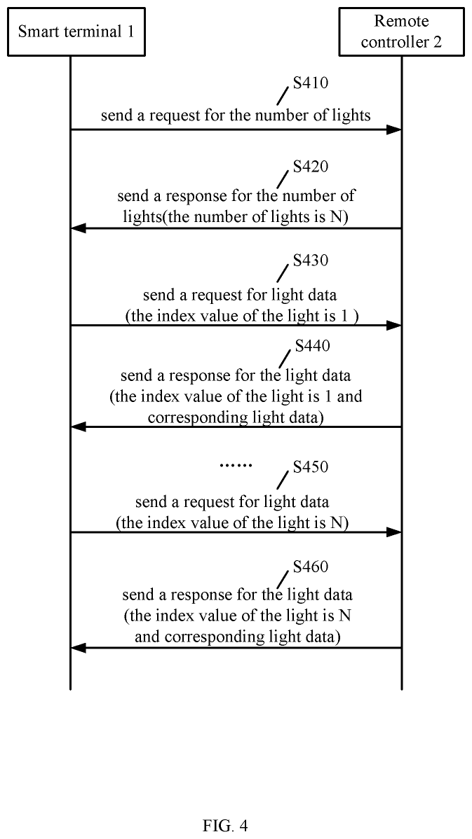

Referring now to FIG. 4, shown is a flow diagram of an example process for obtaining the status data of the smart light in the remote controller by the smart terminal, in accordance with embodiments of the present invention. In this particular example, a smart light is utilized. The process for obtaining the status data of the smart light in the remote controller by the smart terminal can include, at S410, the smart terminal sending a request for the number of lights to the remote controller. At S420, the remote controller can send a response for the number of lights to the smart terminal in response to the request for the number of lights, e.g., the number of lights is N.

At S430, the smart terminal can send a request for data of the light to the remote controller. The request for the data of the light may include an index value of the light, and the initial value of the index value of the light is 1. At S440, the remote controller can obtain corresponding data of the light according to the request for the data of the light, and may send a response for the data of the light to the smart terminal. For example, the response for the data of the light can include the index value of the light and corresponding data of the light. Then, S430-S440 may be repeated. The index value of the light may be increased by one every time until the index value of the light is equal to the number of lights; that is, S450 and S460. Thus, the state data of the smart lights in the remote controller can be obtained one by one. One skilled in the art will recognize that any suitable method for obtaining the information of the smart lights in the remote control can be utilized in certain embodiments.

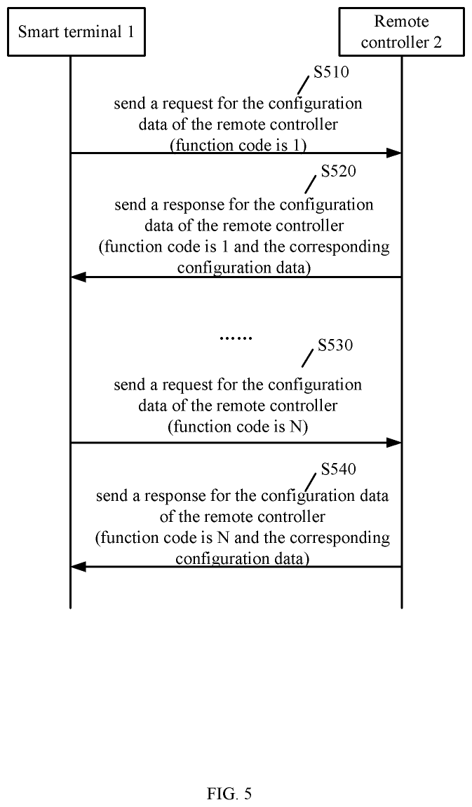

Referring now to FIG. 5, shown is a flow diagram of an example process for obtaining the configuration data of the remote controller by the smart terminal, in accordance with embodiments of the present invention. In this example, a smart light is taken as the electric appliance. The smart terminal obtaining the configuration data of the remote controller can include the following steps. At S510, the smart terminal can send a request for the configuration data of the remote controller to the remote controller. For example, the configuration data of the remote controller can include the function code of the remote controller, and the initial value of the function code is 1.

At S520, the remote controller can send a response for the configuration data of the remote controller to the smart terminal in response to the request for the configuration data of the remote controller. The response for the configuration data of remote controller can include the function code and its corresponding configuration data. Then, S510-S520 may be repeated. The function code can be increased by one every time until the function code is equal to the number of lights; that is, S530 and S540. Thus, the configuration data of the remote controller can be obtained one by one.

Therefore, the request for the number of the smart lights and the response for the data of the light sent by the remote controller can be obtained one by one by the smart terminal, such that the smart terminal can obtain all the information of the smart lights in the remote controller, thereby reducing the probability of missing. Then, the smart terminal can combine the obtained configuration data of each function code and status data of each electrical appliance with those of the smart terminal, and may sends the combined configuration data and status data of the electrical appliance to the remote controller one by one to realize synchronization.

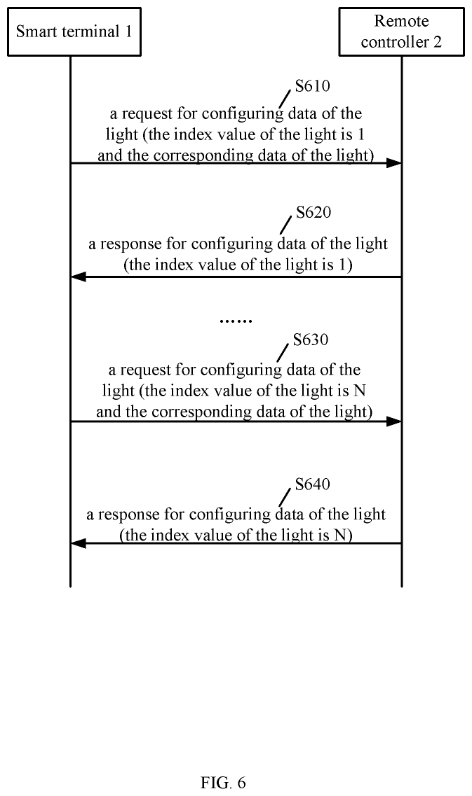

Referring now to FIG. 6, shown is a flow diagram of an example process for configuring the status data of the smart lights in the remote controller by the smart terminal, in accordance with embodiments of the present invention. In this example, the process for configuring the status data of the smart lights in the remote controller by the smart terminal can include the following steps. At S610, the smart terminal may send a request for configuring data of the light to the remote controller. The request can include an index value of the light and a corresponding data of the light. For example, the initial value of the index value of the light is 1. At S620, the remote controller can send a response for configuring data of the light to the smart terminal, in response to the request for configuring data of the light. Here, the response can include the index value. Then, S610-S620 may be repeated. The index value of the light can be increased by one every time until the index value of the light is N; that is, S630 and S640.

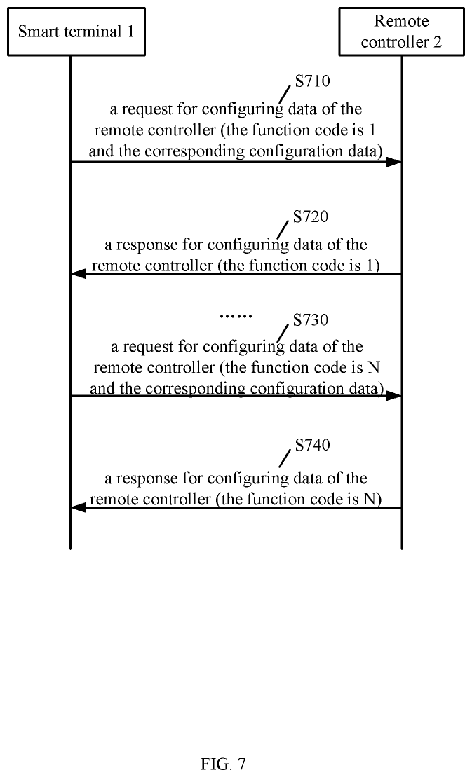

Referring now to FIG. 7, shown is a flow diagram of an example process for configuring the data of the remote controller by the smart terminal, in accordance with embodiments of the present invention. In this example, the process for configuring the data of the remote controller by the smart terminal can include the following steps. At S710, the smart terminal may send a request for configuring data of the remote controller to the remote controller. The request can include a function code of the remote controller and corresponding configuration data. For example, the initial value of the function code is 1. At S720, the remote controller may send a response for configuring data of the remote controller to the smart terminal, in response to the request for configuring data of the remote controller. Here, the response can include the function code. Then, S710-S720 may be repeated. The function code of the remote controller can be increased by one every time until the function code is N; that is, S730 and S740.

Therefore, the request for the number of the smart lights and the response for the data of the smart lights can be sent by the remote controller one by one, such that the networking data and groping data of the smart terminal and the smart lights in the remote controller are the same, and the user can control the same group of smart lights through the smart terminal or remote controller. In addition, the smart terminal can configure the request for the data of the remote controller one by one, and may send the configuration data of each function code of the remote controller to the remote controller, such that the remote controller can realize the multi-function control of the smart light, and is thus not limited to the control of simple buttons on the remote controller.

Exemplary customized data of the remote controller are shown in Tables 1 to 3. Among them, Table 1 exemplifies the custom data of the function of the remote controller, Table 2 the configuration data of each function code of the remote controller, and Table 3 the configuration data of the button combination of the remote controller. When the function of buttons on the remote controller are to be changed, one can configure the custom data of the corresponding function of the remote controller through the smart terminal, and may then change the function of the button on the remote controller through the data synchronization function of the smart terminal and the remote controller.

TABLE 1
Custom data of the function of the remote controller.

| Index | | | | | |
|---|---|---|---|---|---|
| value | | | | | |
| of | Bluetooth | Network | Grouping | Switching | Brightness |
| lights | address | address | number | state | state |
| 0 | 0X123B4C6D8E | 0X0001 | 1 | 0 | 0 |
| 1 | 0X123B4C6D7E | 0X0002 | 1 | 1 | 75 |
| 2 | 0X12344C6D8E | 0X0003 | 1 | 0 | 0 |
| 3 | 0X123B4C6D8F | 0X0004 | 1 | 0 | 0 |
| 4 | 0X123B3C6D8E | 0X0005 | 2 | 0 | 0 |
| 5 | 0X123A4C6D8F | 0X0006 | 3 | 0 | 0 |
| . . . | . . . | . . . | . . . | . . . | . . . |
| N | 0X126B4C6D8A | 0X01FFF | 4 | 0 | 0 |

TABLE 2
Configuration data of each function code of the remote controller.

| | | Button combination configuration | | | |
|---|---|---|---|---|---|
| | | | | | Button |
| Function | Function | Dip | Main | Auxiliary | pressing |
| code | name | switch | button | button | time(s) |
| 0X00 | Reset | Up | Turn-off | — | 6 |
| | | | button | | |
| 0X01 | Group 1 | Up | Button 1 | — | 3 |
| 0X02 | Group 2 | Up | Button 2 | — | 3 |
| 0X03 | Group 3 | Up | Button 3 | — | 3 |
| . . . | . . . | . . . | . . . | . . . | . . . |
| 0X0D | Data | Down | Turn-off | — | 6 |
| | synchronization | | button | | |

TABLE 3
Configuration data of the button combination of the remote controller.

| Button | Functional | Reserved | | | | |
|---|---|---|---|---|---|---|
| combination | description | | | | | |
| configuration | Bit | 15 | 14 | 13 | | |
| | Value | | | | | |
| | Functional | Button pressing time | | | | |
| | description | | | | | |
| | Bit | 12 | 11 | 10 | 9 | |
| | Value | 0-15:0-15 s | | | | |
| | Functional | Auxiliary button | | | | |
| | description | | | | | |
| | Bit | 8 | 7 | 6 | 5 | |
| | Value | 0: Reserved 5: Turn-on button 15: Invalid | | | | |
| | Functional | Main button | | | | Dip switch |
| | description | | | | | |
| | Bit | 4 | 3 | 2 | 1 | 0 |

| | | |
|---|---|---|
| Value | 0: Reserved 5: Turn-on button 15: Invalid | 0: Down |
| | 1: Button 1 6: Turn-off button | 1: Up |

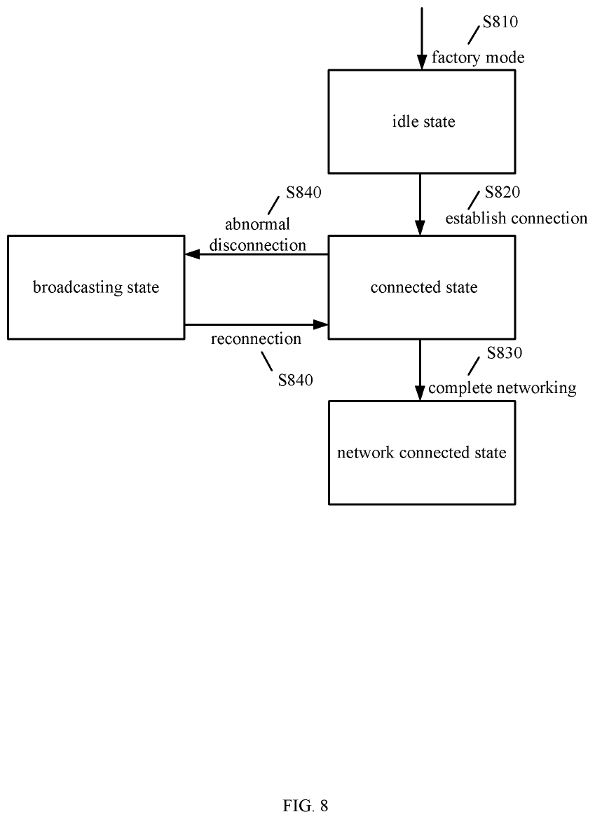

Referring now to FIG. 8, shown is a diagram of an example operation state transition, in accordance with embodiments of the present invention. In this example, the smart light may have two modes: a factory mode and an operation mode, for example. The operation states of the smart light may be divided into four types: an idle state, a connected state, a network connected state, and a broadcasting state, for example. Further, the operation state transition of the smart light can include the following steps. At S810, the operation mode of the smart light may be restored to the factory mode. For example, the operation mode of the smart light can be restored to the factory mode to make the smart light enter the idle state. Here, the idle state can mean that the smart light has neither joined the mesh network nor established a data connection with the smart terminal or the remote control.

In this particular example, the operation mode of the smart light can be restored to the factory mode by turning on and off continuously for 7 times during use; that is, all data stored in the smart light may be restored to the default values. Optionally, the default mode of the smart light when leaving the factory is the factory mode; that is, the smart light has zero data storage. At S820, a connection may be established. For example, the smart light can establish the data connection with the smart terminal or the remote controller, such that the smart light enters the connected state. At S830, networking may be completed.

For example, the smart light can enter the network connected state after the networking is completed. The network connected state may mean that the smart light and the smart terminal and/or the remote controller have completed the network connection process and joined the mesh network, and the smart terminal or the remote controller can control the smart light for switching, brightness adjustment, and color temperature adjustment. At S840, abnormal disconnection and reconnection can occur. For example, after the smart light establishes the data connection with the smart terminal and/or the remote controller, the smart light may enter the broadcasting state due to abnormal disconnection. In this case, the smart light can resend a connectable broadcast message to try to re-establish the data connection with the smart terminal or remote controller.

In this example, both the smart terminal and the remote controller can complete the networking of electrical appliances. If one of them completes the networking of the electrical appliances, then the data synchronization operation can be performed through the smart terminal and the remote controller to complete the information interaction, thereby realizing the control of the network-connected electrical appliances. In addition, due to design limitations of the remote controller, the remote controller may not realize the setting of complex scenes, and the smart terminal can provide the grouping of electrical appliances and the setting of scenes through a highly operable visual interface. After the smart terminal completes the scene setting, the configuration data of the scene may be written to the remote controller through the data synchronization operation, such that the remote controller can realize the custom setting of complex scenes.

As described above, by sending the configuration instruction and the control instruction, the electrical appliance control unit can join the mesh network, the electrical appliance corresponding to the electrical appliance control unit may be controlled, and the configuration data and the status data of the electrical appliances between the smart terminal and the remote controller can be synchronized. In this way, data synchronization between the smart terminal and the remote controller can be realized. In addition, grouping control of multiple electrical appliances can be realized.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A data synchronization method for synchronizing data between a first device and a second device, wherein the first and second devices are configured to send configuration instructions to control electrical appliances to join a mesh network and send control instructions to the electrical appliances that join the mesh network, the method comprising:
a) establishing, by the second device, a communication connection with the first device, in accordance with a connectable broadcast sent by the first device;
b) obtaining, by the second device, configuration data and status data of the electrical appliances stored in the first device;
c) merging, by the second device, the obtained configuration data and status data of the electrical appliances with local configuration data and status data of the electrical appliances;
d) sending, by the second device, the merged configuration data and status data of the electrical appliances to the first device, in order to realize synchronization; and
e) wherein the first device is one of a smart terminal and a remote controller, and the second device is the other one of the smart terminal and the remote controller.

2. The data synchronization method of claim 1, wherein the first and second devices are connected through Bluetooth low energy communication, and the mesh network is based on a Bluetooth low energy protocol.

3. The data synchronization method of claim 1, wherein the first and second devices communicate through a Bluetooth low energy broadcast channel and/or a Bluetooth low energy data channel.

4. The data synchronization method of claim 1, wherein the configuration data comprises grouping data for the electrical appliances, networking data for the mesh network, and custom data for the functions of the remote controller.

5. The data synchronization method of claim 1, further comprising obtaining, by the second device, the configuration data and the status data of each electrical appliance stored in the first device one by one through the communication connection.

6. The data synchronization method of claim 1, further comprising sending, by the second device, the merged configuration data and status data of each electrical appliance one by one to the first device to achieve synchronization.

7. An electrical appliance control system, comprising:
a) a plurality of electrical appliance control units configured to receive configuration instructions to join a mesh network, and to control corresponding electrical appliances according to control instructions received from the mesh network; and
b) a smart terminal and a remote controller configured to send the configuration instruction and the control instruction to the electrical appliance control units, and to synchronize configuration data and appliance state data through a communication connection.

8. The electrical appliance control system of claim 7, wherein:
a) the remote controller is configured to perform custom settings according to the configuration data; and
b) the configuration data comprises at least one of grouping data for the electric appliance control units, networking data of the mesh network, and custom data of functions of the remote control.

9. The electrical appliance control system of claim 8, wherein:
a) the plurality of electrical appliance control units, the smart terminal, and the remote controller are connected through Bluetooth low energy communication; and
b) the mesh network is based on a Bluetooth low energy protocol.

10. The electrical appliance control system of claim 9, wherein the plurality of electrical appliance control units, the smart terminal, and the remote controller communicate through a Bluetooth low energy broadcast channel and/or a Bluetooth low energy data channel.

11. The electrical appliance control system of claim 8, wherein the electrical appliance control unit is configured to relay the control instruction in the mesh network.

12. The electrical appliance control system of claim 8, wherein the smart terminal comprises:
a) a communication unit; and
b) a control unit configured to control the communication unit to send the configuration instruction and the control instruction, and to synchronize the configuration data and the appliance status data with the remote controller through the communication unit.

13. The electrical appliance control system of claim 8, wherein the remote controller comprises:
a) a communication unit; and
b) a control unit configured to control the communication unit to send the configuration instruction and the control instruction, and to synchronize the configuration data and the appliance status data with the smart terminal through the communication unit.

14. The electrical appliance control system of claim 8, wherein the smart terminal is configured to:
a) establish the communication connection according to a connectable broadcast sent by the remote controller;
b) obtain configuration data and appliance status data through the communication connection;
c) merge the obtained configuration data and appliance status data with the configuration data and appliance state data of the smart terminal; and
d) send the combined configuration data and appliance status data to the remote controller to achieve synchronization.

15. The electrical appliance control system of claim 8, wherein the smart terminal is configured to:
a) obtain the configuration data of each function code and the status data of each electrical appliance from the remote controller; and
b) send the configuration data of each function code and the status data of each electrical appliance to the remote controller after merging with local data.
